(19) United States
(12) Patent Application Publication
(10) Pub. No.: US 2004/0046297 A1
(43) Pub. Date: Mar. 11, 2004

(54) High profile balable coils and innersprings

(76) Inventors: Larry DeMoss, Jamestown, NC (US); Bruce G. Barman, Greensboro, NC (US)

Correspondence Address: JAMES C. SCOTT, ESQ., ROETZEL & ANDRESS, 1375 E. 9TH STREET, ONR CLEVELAND CENTER, 10TH FLOOR, CLEVELAND, OH, 44114, US

(21) Appl. No.: 10/238,083

(22) Filed: Sep. 10, 2002

(51) Int. Cl. F16F 1/00

(52) U.S. Cl. 267/142

(57) ABSTRACT

A high profile coil with an overall height in a range of 6¾ to 7½ inches maintains axially alignment under compression. A high profile innerspring constructed with the high profile coils can be baled with other high profile innersprings in a baling machine without spin-out or lateral distortion. On-axis of compression of the coils under various loading conditions avoids contact with adjacent coils in an innerspring.

### FIELD OF THE INVENTION

The present invention pertains generally to coils, springs and innerspring assemblies for use in reflexive support devices such as seating and bedding and, more particularly, to a coil and innerspring designs which are able to be compressed in a baling process for shipping and handling.

### BACKGROUND OF THE INVENTION

An innerspring assembly, used as a reflexive and supportive core to support devices such as seating and bedding, is generally made of a plurality of coils or springs attached in various arrangements. In a wire-form innerspring, the coils are usually helical, often with the ends being punch-formed to provide a foot or supporting surface for interface with overlying padding and upholstery. Innerspring coils are commonly connected together in a matrix or array by lacing adjacent turns with cross helical wires which run the width or length of the innerspring. The height of the coils measured end-to-end (also referred to as “length”) dictates of the height of the innerspring, which in turn dictates the overall height or thickness of a mattress or seating surface.

An innerspring of increased overall height made with extended height coils is desirable in the marketplace to provide a reflexive support surface with increased loft and a greater range of compression. One difficulty however associated with innerspring manufacture and handling is with respect to the practice of baling, wherein innerspring units are compressed along the coil axes to a small fraction of the uncompressed height in order to reduce shipping volume. This is necessary for shipment of innersprings from a separate manufacturing facility to a finished product production facility, such as a mattress plant. Baling of innersprings made with coils of conventional height in the five to six inch range can be somewhat problematic in maintaining axial alignment of all of the coils of the array. This challenge is made greater with coils of increased height, which has been the manufacturing and handling limitation on innerspring height. The problem is exacerbated by coils with central taper helical design in which the central area of the coil body has a tapered narrow diameter relative to the ends of the coil, making the coil axially unstable under the full compression of the baling process, resulting in the coils spinning or deforming out of axial alignment under the pressure of baling.

It is an object of the present invention to provide an improved coil spring of increased overall height which maintains axially alignment and dimensional stability during and after the baling process.

### SUMMARY OF THE PRESENT INVENTION

The present invention provides a high profile innerspring coil with an increased overall height which maintains axial alignment during and after the baling process. The coil spring includes a resilient material such as steel wire spirally wound to form a coil body and an end convolution at each end of the coil. Additionally, the coil spring has an uncompressed total height in a range of approximately six and three-quarters inches to seven and one-half inches, or in the approximate range of 170 to 190 mm. As further explained, coil height is measure end-to-end and is alternately referred to herein as length

The unique dimensions of the high profile innerspring coil of the invention enable an innerspring to maintain dimensional stability throughout the baling and unbaling process. The pitch and diameter of the convolutions or turns of the high profile coil are designed to allow the coil to be fully compressed and uncompressed along the coil axis. In one general design aspect of the invention, the high profile coil has a center convolution which has a pitch greater than a pitch of adjacent convolutions, and an outer diameter which is less than an outer diameter of adjacent convolutions. The pitch of the end convolutions of the coil is less than the pitch of all other convolutions of the coil. The high profile coil has a compression force range of 1.55 to 1.95 pounds per inch as measured by a Carlson tester, and when assembled in an innerspring is able to be baled in a baling machine and compress along the coil axes.

These and other aspects of the present invention are herein described in further detail, with reference to the accompanying Figures, the illustrated embodiments being representative of only some of they ways in which the principles and concepts of the invention can be executed and employed.

### DESCRIPTION OF THE FIGURES

In the accompanying Figures:

FIG. 1 is an elevation view of the high profile innerspring coil of the present invention;

FIG. 2 is a top view of the high profile innerspring coil spring of the present invention;

FIG. 3 is an elevation view of an alternate embodiment of the high profile innerspring coil spring of the present invention;

FIG. 4 is a top view of the high profile innerspring coil of FIG. 3; and

FIG. 5 is a perspective view of a portion of an innerspring constructed with the high profile coil of the present invention.

### DETAILED DESCRIPTION OF PREFERRED AND ALTERNATE EMBODIMENTS

With reference to the Figures, there is shown a high profile innerspring coil, indicated at 10, with an overall finished end-to-end length or height dimension in an approximate range of six and three quarters to seven and one half inches (or the approximate range of 170-190 mm). The coil 10 is made of helical formed wire, for example 12-16 gauge, in the form of a helical body 13, with contiguous end convolutions 16 at opposite ends of the coil body. In this particular embodiment there are three convolutions or turns which make up the body of the coil, including the intermediate body convolutions 14a and 14b, and a center convolution 12. Alternate embodiments of the coil of the invention may be constructed with different configurations, such as different numbers of convolutions or turns, and different shapes to the coil ends, as further described. In this particular embodiment of a five turn helical coil, the center convolution 12 has the smallest diameter, and the diameters of the adjoining intermediate body convolutions 14a and 14b being larger by a defined degree, and the diameters of the end convolutions 16 being largest. The intermediate body convolutions 14a and 14b are stabilized by the larger end convolutions 16, and compress within the diameter of the end convolutions 16 as the coil is compressed on-axis.

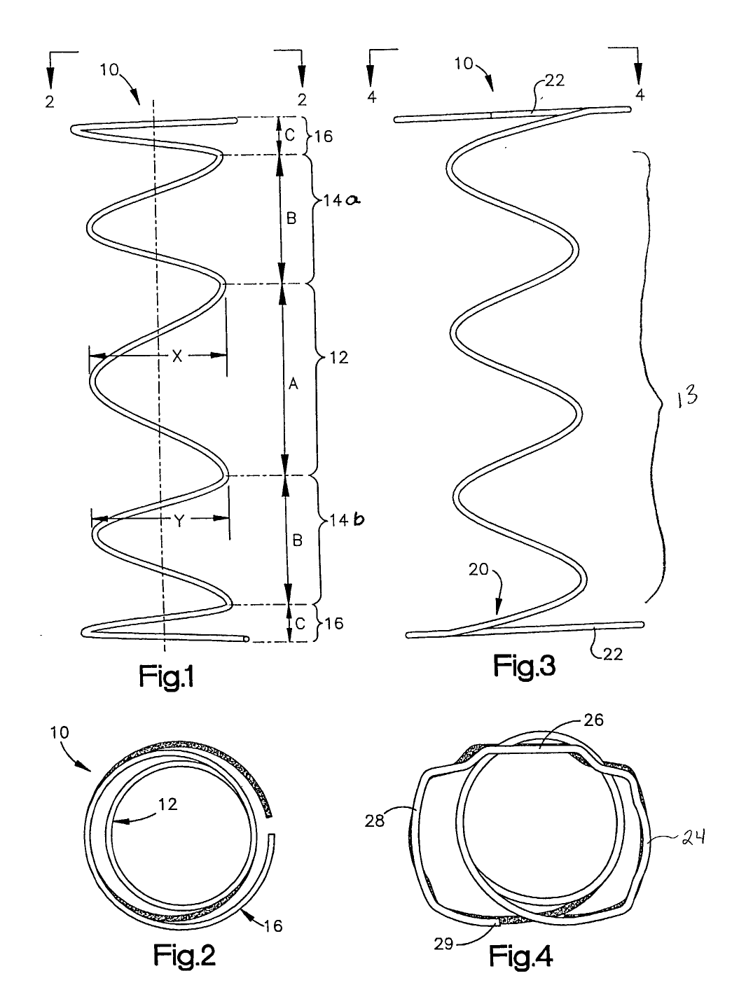

FIGS. 1 and 2 illustrate the coil 10 in a raw form as produced by conventional coiler wire forming equipment, with the end convolutions 16 in generally circular form as shown in FIG. 2. For the coil 10 in the raw form may be subsequently formed with the end convolutions as shown in FIG. 4, or in any other form, and with the other coil parameters as described herein. The raw coil should have a preferred total coil height in the approximate range of 8½ inches to 9½ inches. This is an important parameter which can be set and measured in the course of manufacturing high profile coils in accordance with the invention to ensure a desired finished height in the range of 6¾ inches to 7½ inches.

In accordance with the design principles of the invention in providing a high profile coil which is readily balable in a conventional baling process, the coil dimension measured from an outermost edge of one convolution to the adjacent convolution is referred to herein as “pitch” and designated “A”, “B” and “C” in FIG. 1. “A” represents the pitch of the center convolution 12. “B” represents the pitch of the intermediate convolutions 14. “C” represents the pitch of the end convolutions 16. The center convolution has an outer diameter (O.D.), measured laterally from an outer tangent of the center convolution to the opposing turn, represented by “x”, and an intermediate convolution O.D. represented by “y”. For coil with a coil height/length of approximately 7 inches (178 mm), preferably the center convolution O.D. “x” is in a range of 50 mm to 53 mm. In accordance with the design principles of the invention, the intermediate convolution O.D. “y” must be at least 1 mm larger than the center convolution O.D. “x”. These dimension are critical to the performance and behavior of the coil, particularly under compression and under the high compression of baling. The behavior of the coil under compression is ideally “on-axis”, meaning that the coil compresses along the axis of the helical coil body with little or no lateral distortion. On-axis compression is critical to maintain alignment of the coils in a matrix, as in an innerspring assembly and particularly in large innerspring assemblies as used in mattress construction and to avoid any contact with adjacent coils which produces a clicking sound as the coils/innerspring are loaded and unloaded. As used herein, the term “balable” refers to the characteristic of a coil, or innerspring assembly made with such coils, which compresses and decompresses on-axis, particularly under the compressive load of an innerspring baling machine used, for example, in mattress manufacturing.

For dimensional stability in a high profile balable coil, a finished coil 10 made in accordance with the design principles of the invention should have the following dimensional ranges. The center convolution 12 should have a pitch dimension in the range of 54-58 mm, and an O.D. in the range of 51-55 mm. The intermediate convolutions 14 should have a pitch in the range of 53-60 mm, and an O.D. in the range of 52-55 mm. The end convolutions 16 should have a pitch in the range of 25-35 mm, and an outer diameter (O.D.) in the range of 59-65 mm. The high profile coil of the invention preferably has a total uncompressed height in the range of 6¾ inches to 7½ inches.

The following dimensions are also representative of desired dimensional ranges of the pitch and O.D. measurements of the high profile coil of the invention in its various states of manufacture prior to heat treatment and prior to initial compression (setting), and after heat treatment but prior to initial compression (setting), and in the finished state.

| | | Pitch (mm) | O.D. (mm) |
|---|---|---|---|
| Pre-Heat treatment/ | | | |
| Pre-compression (Raw) | | | |
| Center convolution | (A) | 59-67 | 50-54 |
| Inter, convolutions | (B) | 59-66 | 52-55 |
| End convolutions | (C) | 25-35 | 59-65 |
| Post-Heat treatment/ | | | |
| Pre-compression | | | |
| Center convolution | (A) | 58-63 | 50-55 |
| Intermediate convolutions | (B) | 59-66 | 52-5 5 |
| End convolutions | (C) | 25-3 5 | 59-65 |
| Post-Heat treatment/ | | | |
| Post-Compression (Finished) | | | |
| Center convolution | (A) | 54-58 | 51-55 |
| Intermediate convolution | (B) | 53-60 | 52-55 |
| End convolutions | (C) | 25-35 | 59-65 |

After the coil 10 has been heat treated, but prior to initial compression or “set”, the coil should have the following dimensions. The end convolutions 16 should have a pitch dimension in the range of 25-35 mm, and an O.D. in the range of 59-65 mm. The intermediate body convolutions 14 should have a pitch in the range of 59-66 mm, and an O.D. in the range of 52-55 mm. The center convolution 12 should have a pitch in the range of 58-63 mm, and an O.D. in the range of 50-55 mm.

After the coil 10 has been heat treated and compressed, the coil should have the following dimensions. The end convolutions 16 should have a pitch in the range of 25-35 mm, and an O.D. in the range of 59-65 mm. The intermediate body convolutions 14 should have a pitch in the range of 53-60 mm, and an O.D. in the range of 52-55 mm. The center convolution 12 should have a pitch in the range of 54-58 mm, and an O.D. in the range of 51-55 mm.

If the O.D.s of any of the described convolutions is greater than the described ranges, the coils 10 will not compress on-axis in a baling operation, i.e., in an innerspring baling machine, and may touch together at laterally tangential points when under a load in an innerspring assembly. If the described O.D.s of the convolutions are below these ranges, the coils will not be dimensionally stable, particularly under the compressive load of baling, and will spin-out of the coil body out of alignment with the end convolutions, i.e., not compress on-axis. Also, if the described pitches between the convolutions is larger than the described ranges, the coils 10 will not be dimensionally stable, particularly under baling compression. And if the pitch between the convolutions is smaller than the described ranges, the coil 10 will resist baling and spin-out by lateral deflection of the body convolutions relative to the end convolutions.

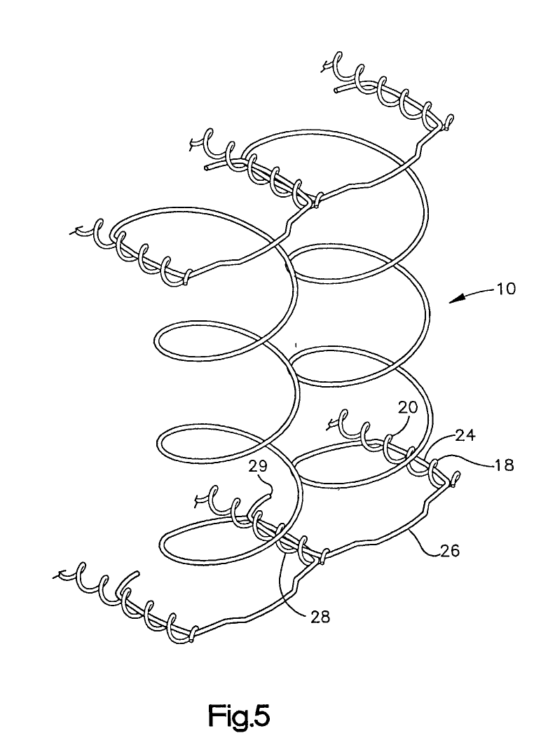

As shown in FIG. 5, one example of how coil springs 10 may be interconnected in an innerspring assembly is by lacing end convolutions 16 together with cross helical wires 18. Other examples include the use of fabric or other encapsulation to arrange coils in a parallel axis array, or use of other types of fastening devices to hold an array of coils in a matrix arrangement with axes of the coils generally parallel. In the illustrated example, the cross helical lacing wires 18 extend transversely between the rows of coils 10, in this case along the end convolutions 16 at opposing ends of the coils, to form an innerspring with a thickness equal to the axial length of the coils. Although shown laced together in a particular radial orientation, it is understood that one or more of the coils may be rotated relative to other coils in the innerspring assembly.

The compressive force required to compress coil 10, having an overall height or length in the range of six and three quarters to seven and one half inches without disrupting the baling process, is 1.55 to 1.95 pounds per inch, as measured by a Carlson type spring tester. As known in the art, a Carlson tester provides a standardized spring rate test which measures the amount of force required to compress a coil one inch beyond compression to twenty percent of unloaded height or length. Based on this measurement, the compression force required to bale a coil 10 is determined. It has been discovered by the inventors that a coil 10 having the described dimensions, if compressible in the Carlson tester within the range of 1.55 to 1.95 pounds per inch, will when assembled in an innerspring, bale substantially on-axis in a baling machine, without interference with adjacent coils. The baling referred to includes bulk baling of at least several innersprings stacked together, separated by a sheet of material such as heavy paper, and compressed in the baler in bulk, as is common practice in the industry. The coils 10 are designed to compress on-axis under the baling pressure required to simultaneously bale multiple innersprings.

As shown in FIG. 2, the end convolutions 16 of the coil 10 can be formed generally circular, terminating the coil in a generally planar form which serves as the supporting end structure of the coil for attachment to adjacent coils and for the overlying application of padding and upholstery. Other configurations of the end convolutions are executable within the design principles of the high profile coil of the invention.

FIGS. 3 and 4 illustrate an alternate embodiment of the invention wherein the coil 10 has a uniquely configured end convolution 16 for the described high profile coil. As shown in FIGS. 3 and 4, the end convolution 16 is formed with a first offset 24 which extends from the intermediate body convolution 14a or 14b through a connecting segment 20 which extends at an angle between the intermediate convolution and the end convolution. The connecting segment 20 can be included in one or both ends of the coil. The length of the connecting segment 20 may be adjusted to alter the spring characteristics of the coil without altering the on-axis compression performance of the coil in an innerspring. The first offset segment 24 is connected at one end to a second offset segment 26 which is generally orthogonal to and laterally disposed relative to the first offset segment 24. The second offset segment 26 is connected at a second end to a third offset segment 28, which is generally orthogonal to the second offset segment and generally opposed to the first offset segment, and which terminates the coil at terminus 29. The connecting segment 20 is adjustable in length to vary the compression and firmness of the coil 10. In addition to serving as support members at the ends of the coil, the first and third offset segments 24, 28 also serve as inter-coil connection members which are laced together with adjacent coils in an innerspring assembly, as shown in FIG. 5. Although not circular in form, the end convolution 16 formed with the offsets is considered to have a diameter or outer diameter as measured from an offset across the end of the coil. In the circular form shown in FIG. 2, the outer diameter of the end convolution is measured across the end of the coil.

The principles of the invention are applicable to other types of wire-form coils or springs, which may vary in design and dimension. The form of the end convolutions of the coils of the invention are not critical to the linear behavior of the coils under full compression. Also, the orderly compression and decompression of the coils of the invention, or innersprings constructed with the coils of the invention, is applicable not only to the process of baling innersprings as an intermediate handling step in product production, but also advantageous in the end use of the coils or innersprings, such as full compression of a seating or bedding structure which may occur in a folding or storage operation.

What is claimed as the invention is:

1. A helical wire form coil comprising a center convolution, at least two intermediate convolutions which extend from the center convolution, and an end convolution attached to each intermediate convolution, the coil having a length measured from one end convolution to an opposite end convolution in a range of six and three quarters to seven and one half inches, and being able to be compressed axially by a force in a range of 1.55 to 1.95 pounds per inch as measured by a Carlson tester.

2. The coil of claim 1 wherein the height of the coil in an uncompressed state is approximately seven inches.

3. The coil of claim 1 wherein the center convolution has a pitch greater than a pitch of an adjacent convolution.

4. The coil of claim 1 wherein the center convolution has an outer diameter which is less than an outer diameter of a convolution adjacent to the center convolution.

5. The coil of claim 1 wherein the convolutions adjacent to the center convolution are symmetrical in pitch.

6. The coil of claim 1 wherein the convolutions adjacent to the center convolution have the same outer diameter.

7. The coil of claim 1 wherein the intermediate convolutions are symmetrical in pitch.

8. The coil of claim 1 wherein the intermediate convolutions have the same outer diameter.

9. The coil of claim 1 wherein an end convolution has a pitch less than the center convolution.

10. The coil of claim 1 wherein an end convolution has a pitch less than an intermediate convolution.

11. The coil of claim 1 wherein the end convolutions have an outer diameter greater than an outer diameter of the center convolution.

12. The coil of claim 1 wherein the end convolutions have an outer diameter greater than an outer diameter of the intermediate convolutions.

13. The coil of claim 1 wherein an end convolution has at least one offset segment.

14. The coil of claim 1 comprising five convolutions.

15. The coil of claim 1 wherein the center convolution has a pitch in the range of 59-67 mm and an outer diameter in the range of 50-54 mm prior to heat treatment and prior to compression.

16. The coil of claim 1 wherein the convolutions adjacent to the center convolution have a pitch in the range of 59-66 mm and an outer diameter in the range of 52-55 mm prior to heat treatment and prior to compression.

17. The coil of claim 1 wherein the center convolution has a pitch in a range of 54-58 mm and an outer diameter in a range of 51-55 mm.

18. The coil of claim 1 wherein the convolutions adjacent the center convolution have a pitch in a range of 53-60 mm and an outer diameter in a range of 52-55 mm.

19. The coil claim 1 wherein the end convolutions have a pitch in a range of 25-35 mm and an outer diameter in a range of 59-65 mm.

20. The coil of claim 1 having a Carlson tester compression force in a range of 1.55 to 1.95 pounds per inch.

21. The coil of claim 1 further comprising a connecting segment between an intermediate convolution and an end convolution.

22. A generally helical coil for use in an innerspring, the coil comprising a center convolution, at last one intermediate convolution which extends from the end of the center convolution, and an end convolution which extends from each intermediate convolution, the coil having a height dimension measured from one end convolution to the other end convolution in a range of 6¾ inches to 7½ inches when not under compression, the center convolution having a pitch and outer diameter dimensions less than pitch and outer diameter dimensions of the intermediate convolutions.

23. The coil of claim 22 having a Carlson tester compression force in a range of 1.55 to 1.95 pounds.

24. The coil of claim 22 further comprising a connecting segment between an intermediate convolution and an end convolution.

25. An innerspring constructed with interconnected high profile coils, the high profile coils comprising:
a center convolution;
at least one intermediate convolution on opposite sides of the center convolution;
an end convolution attached to an intermediate convolution on each side of the center convolution,
the center convolution having pitch and outer diameter dimensions less than pitch and outer diameter dimensions of the intermediate convolutions;
the coil having a height measure from one end convolution to an opposite end convolution in range of 6¾ to 7½ inches.

26. The innerspring of claim 25 wherein the intermediate convolutions of the coils have identical pitch and outer diameter dimensions.

27. The innerspring of claim 25 wherein the coils have a Carlson tester compression force in a range of 1.55 to 1.95 pounds per inch.

28. The innerspring of claim 25 wherein the coils further comprise a connecting segment between an intermediate convolution and an end convolution.

29. A high profile innerspring comprising a plurality of high profile coils interconnected so that axes of the coils are generally parallel and the coils aligned such that ends of the coils are in a first common plane which forms a support surface of the innerspring, and opposite ends of the coils in a second common plane which forms an opposite support surface of the innerspring, the high profile coils having an end-to-end length dimension in a range of 6¾ to 7½ inches, the coils having a compression force in a range of 1.55 to 1.95 pounds per inch as measured by a Carlson tester.

30. The innerspring of claim 29 wherein a height of the innerspring measured from a support surface to an opposite support surface in an uncompressed state is approximately seven inches.

31. The innerspring of claim 29 wherein the height of each of the coils of the innerspring in an uncompressed state is approximately seven inches.

32. The innerspring of claim 29 wherein a center convolution of each of the coils of the innerspring has a pitch greater than a pitch of an adjacent convolution.

33. The innerspring of claim 29 wherein a center convolution of each of the coils has an outer diameter which is less than an outer diameter of a convolution adjacent to the center convolution.

34. The innerspring of claim 29 wherein convolutions of the coils adjacent a center convolution are symmetrical.

35. The innerspring of claim 29 wherein convolutions of the coils adjacent a center convolution have a common outer diameter.

36. The innerspring of claim 29 wherein intermediate convolutions of the coils are symmetrical in pitch.

37. The innerspring of claim 29 wherein intermediate convolutions of the coils have a common outer diameter.

38. The innerspring of claim 29 wherein end convolutions of the coils have a pitch less than a center convolution.

39. The innerspring of claim 29 wherein an end convolution has a pitch less than an intermediate convolution.

40. The innerspring of claim 29 wherein an end convolution of the coils has an outer diameter greater than an outer diameter of the center convolution.

41. The innerspring of claim 29 wherein an end convolution of the coil has an outer diameter greater than an outer diameter of the intermediate convolutions.

42. The innerspring of claim 29 wherein an end convolution of the coils has at least one offset segment.

43. The innerspring of claim 29 wherein the coils comprise five convolutions.

44. The innerspring of claim 29 wherein a center convolution of the coils has a pitch in the range of 59-67 mm and an outer diameter in the range of 50-54 mm prior to heat treatment and prior to compression.

45. The innerspring of claim 29 wherein the convolutions of the coils adjacent to the center convolution have a pitch in the range of 59-66 mm and an outer diameter in the range of 52-55 mm prior to heat treatment and prior to compression.

46. The innerspring of claim 29 wherein a center convolution of the coils has a pitch in a range of 54-58 mm and an outer diameter in a range of 51-55 mm.

47. The innerspring of claim 29 wherein the convolutions of the coils adjacent a center convolution have a pitch in a range of 53-60 mm and an outer diameter in a range of 52-55 mm.

48. The innerspring of claim 29 wherein the end convolutions of the coils have a pitch in a range of 25-35 mm and an outer diameter in a range of 59-65 mm.

49. The innerspring of claim 29 wherein the coils have a Carlson tester compression force in a range of 1.55 to 1.95 pounds per inch.

50. The innerspring of claim 29 in combination with mattress materials to in the form of a mattress.
